(19) United States
(12) Patent Application Publication
(10) Pub. No.: US 2010/0070684 A1
(43) Pub. Date: Mar. 18, 2010

(54) MEMORY DEVICE AND OPERATING METHOD THEREOF

(75) Inventors: Hsiu-Hsien CHU, TAIPEI CITY (TW); Pei-Tai CHEN, TAIPEI CITY (TW)

Correspondence Address: BRIAN M. MCINNIS, 12th Floor, Ruttonjee House, 11 Duddell Street, Hong Kong, HK

(73) Assignee: INCOMM TECHNOLOGIES CO., LTD., TAIPEI CITY (TW)

(21) Appl. No.: 12/345,679

(22) Filed: Dec. 30, 2008

(30) Foreign Application Priority Data
Sep. 17, 2008 (TW) 97135676

(51) Int. Cl. G06F 12/02

(52) U.S. Cl. 711/103; 711/E12.006

(57) ABSTRACT

A memory device preloads a command file and a plurality of response files. Whenever a host sends a command to the memory apparatus, the command assigns one of the response files; thereby the host can receive response of the memory apparatus by reading the assigned response file.

### RELATED APPLICATIONS

This application claims priority to Taiwan Application Serial Number 97135676, filed Sep. 17, 2008, which is herein incorporated by reference.

### BACKGROUND

1. Field of Invention

The present invention relates to an electric device and operating method thereof. More particularly, the present invention relates to a memory device and operating method thereof.

2. Description of Related Art

A memory card or flash memory card is a solid-state electronic flash is memory data storage device used with digital cameras, handheld and Mobile computers, telephones, music players, video game consoles, and other electronics. They offer high re-record-ability, power-free storage, small form factor, and rugged environmental specifications. There are also non-solid-state memory cards that do not use flash memory, and there are different types of flash memory.

The memory card includes a controller and a flash memory, where the flash memory includes a lot of memory cells. The controller can control the flash memory. The controller can receive commands and data form the host. Then, the controller can allocate or read data at one position by processing address conversion.

However, hacker may sniff files at one position when the host commands the memory card. For the foregoing reasons, there is a need for a new memory device and operating method thereof to prevent that hacker sniffs files at one position. The present disclosure meets this need.

### SUMMARY

It is therefore an aspect of the present disclosure to provide a memory device.

In accordance with an embodiment of the present disclosure, the memory device comprises a flash memory a transmission interface, a determining module, a allocating module, a parsing module, an executing module and a responding module.

In the embodiment, the flash memory comprising a command position preloaded a command file and a plurality of response positions preloaded a plurality of response files respectively. The transmission interface can receive information. The determining module can determine whether the information is the command value. The allocating module can allocate the information at the command position when the information is the command value. The parsing module can parse the information to find an index of the information, wherein the index assigns to one of the response files. The executing module can execute the information at the command position to generate a response value. The responding module can allocate at one of the response positions according to the index, wherein the one of the response files is preloaded at the one of the response positions.

Accordingly, a plurality of procedure files, such as above-mentioned command file and response files, are preloaded in the memory device. The host can assign different response file for reading the different response value whenever the host commands the memory device, so as to prevent hacker sniff the memory device.

It is another aspect of the present disclosure to provide a method for operating a memory device.

In accordance with another embodiment of the present disclosure, the method for operating the memory device, wherein the memory device has a flash memory having a command position and a plurality of response positions. In the embodiment, the method 400 comprises following steps (1)-(5).

(1) A command file at the command position is preloaded and a plurality of response files are preloaded at the response positions respectively. Additionally, a command value may be saved.

(2) Information is received and then whether the information is the command value is determined.

(3) The information at the command position is allocated when the information is the command value.

(4) The information at the command position is parsed to find out an index of the information, wherein the index assigns to one of the response files.

(5) The information is executed at the command position to generate a response value. In step 460, the response value at one of the response positions is allocated according to the index, wherein the one of the response files is preloaded at the one of the response positions.

Accordingly, a plurality of procedure files, such as above-mentioned command file and response files, are preloaded in the memory device. The host can assign different response file for reading the different response value whenever the host commands the memory device, so as to prevent hacker sniff the memory device.

It is to be understood that both the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a memory device in accordance with an embodiment of the present disclosure;

FIG. 2 is a schematic drawing of operating a conventional memory device;

FIG. 3 is a schematic drawing of operating the memory device in accordance with the embodiment of the present disclosure; and

FIG. 4 is a flow chart of a method in accordance with an embodiment of the present disclosure.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

One technical aspect of the present disclosure is a memory device. The memory device may be easily inserted into existing apparatus, such as flash memory card, USB flash drive or the like, and may be applicable or readily adaptable to all technology nodes.

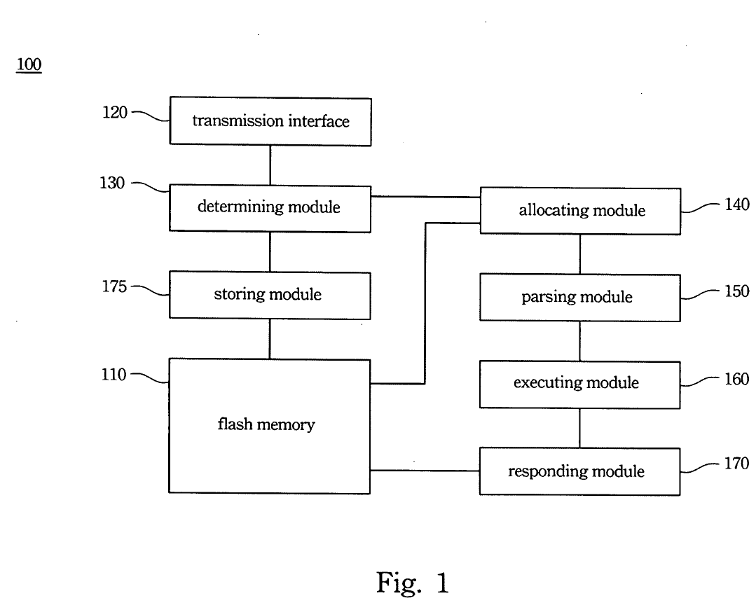

Please refer to FIG. 1. FIG. 1 is one block diagram of the memory device 100 in accordance with an embodiment of the present disclosure. In FIG. 1, the memory device 100 comprises a flash memory 110, a transmission interface 120, a determining module 130, a allocating module 140, a parsing module 150, an executing module 160 and a responding module 170.

In the embodiment, the firmware of the memory device 100 may save a command value. In the memory device 100, a command file may be preloaded at the command position and a plurality of response files may be preloaded at the response positions respectively. The transmission interface 120 can receive information. The determining module 130 can determine whether the information is the command value. The allocating module 140 can allocate the information at the command position when the information is the command value. The parsing module 150 can parse the information to find an index of the information, wherein the index assigns to one of the response files. The executing module 160 can execute the information at the command position to generate a response value. The responding module 170 can allocate at one of the response positions according to the index, wherein the one of the response files is preloaded at the one of the response positions.

Accordingly, a plurality of procedure files, such as above-mentioned command file and response files, are preloaded in the memory device 100. The host can assign different response file for reading the different response value whenever the host commands the memory device 100, so as to prevent hacker sniff the memory device 100.

Please refer to FIG. 1 again. In FIG. 1, the memory device 100 may further comprise a storing module 175. In the embodiment, the storing module 175 can store the information in the flash memory when the information is the command value.

Accordingly, the host can access data in the memory device 100, besides it may command the memory device 100.

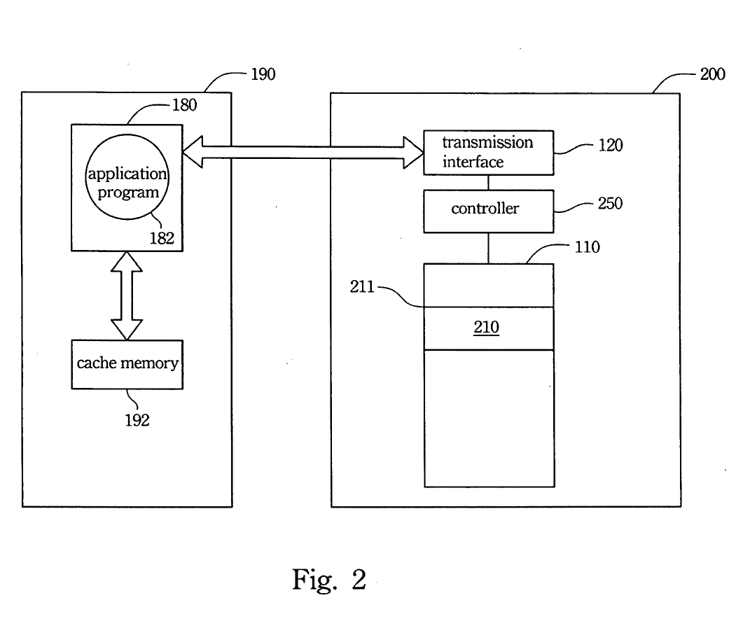

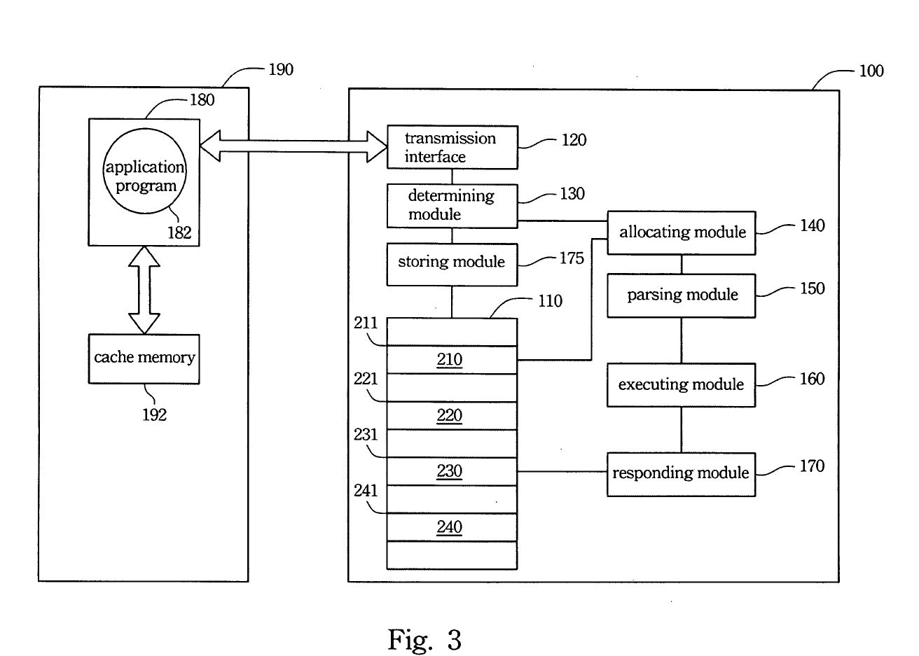

For a more complete understanding of the present disclosure, and the advantages thereof, please refer to FIG. 2 and FIG. 3. FIG. 2 shows a conventional memory device, and relatively FIG. 3 shows the memory device in accordance with the embodiment of the present disclosure.

Please refer to FIG. 2. FIG. 2 is a schematic drawing of operating a conventional memory device 200. The memory device 200 comprises a transmission interface 120, controller 250 and flash memory 110. In the flash memory 110, a command file 210 is preloaded at the command position 211.

In practice, the memory device 200 may electrically connect to the host 190 via its transmission interface 120. Generally, the operating system 180 is installed in the host 190 and thereby the application program 182 may be executed under the operating system 180. The application program 182 may generate a command value. The operating system 180 records the command value in the cache memory 192 when the host 190 writes the command value to the command file 210. In the memory device 200, the transmission interface 120 can receive the command value and then the controller 250 can allocate the command value at the command position 211. Therefore, the controller 250 can execute the command value to generate a response file and then allocate the response file at the command position 211. Unfortunately, the operating system 180 may not read the response file at the command position 211 in the memory device 200 but may read the command value in the cache memory 192 when the host 190 is for the sake of reading the response file, such that the host 190 may fail to read the response file.

Please refer to FIG. 3. FIG. 3 is a schematic drawing of operating the memory device in accordance with the embodiment of the present disclosure. In FIG. 3, the memory device 100 can preload a command file 210 at the command position 211 and preload a plurality of response files 220,230,240 at the response positions 221,231,241 respectively.

In practice the memory device 100 may electrically connect to the host 190 via its transmission interface 120. Generally, the operating system 180 is installed in the host 190 and thereby the application program 182 may be executed under the operating system 180. The application program 182 may generate a command value having an index that assigns to one of the response files 220,230,240 (e.g. the response file 230). The operating system 180 records the command value in the cache memory 192 when the host 190 writes the command value to the command file 210. According to the above-mentioned embodiment, in the memory device 100, the transmission interface 120 can receive the command value and then the determining module 130 can determine the command value. The allocating module 140 can allocate the command value at the command position 211. The parsing module 150 can parse the command value to find the index, wherein the index assigns to one of the response files 220,230,240. The executing module 160 can execute the command value at the command position 211 to generate a response value. The responding module 170 can allocate at one of the response positions 221,231,241 (e.g. the response position 231) according to the index, where the one of the response files 220,230,240 (e.g. the response file 230) is preloaded at the one of the response positions 221,231,241 (e.g. the response position 231).

Then, it should be noted that the host 190 could read the assigned response file (e.g, the response file 230) in accordance with the index to acquire the response value. Although, the operating system 180 may search data of the response value, however the operating system 180 can't find it because the operating system 180 didn't record the response value in the cache memory 192 but recorded the command value in the cache memory 192 previously, such that the host 190 can read the response file.

the operating system 180 may not read the response file at the command position 211 in the memory device 200 but may read the command value in the cache memory 192 when the host 190 is for the sake of reading the response file, such that the host 190 can read the response file correctly.

Another technical aspect of the present disclosure is a method for operating a memory device. The method for operating a memory device may be easily inserted into existing apparatus, such as flash memory card, USB flash drive or the like, and may be applicable or readily adaptable to all technology nodes.

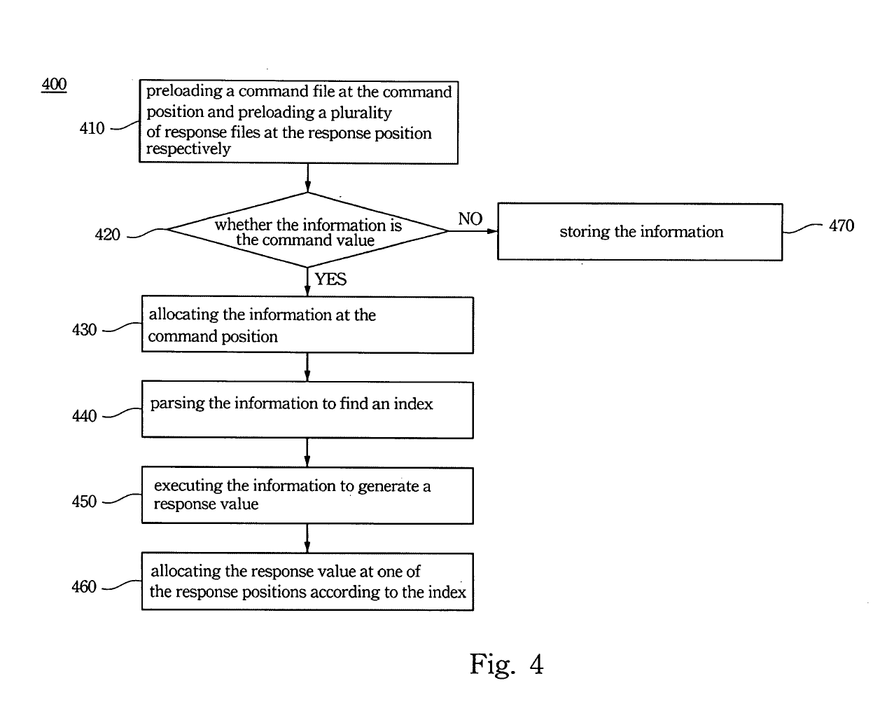

Please refer to FIG. 4. FIG. 4 is a flow chart of the method 400 in accordance with an embodiment of the present disclosure. In FIG. 4, the method is used for operating a memory device, in which the memory device has a flash memory that has a command position and a plurality of response positions. In the embodiment, the method 400 comprises steps 410-460. In step 410, a command file at the command position is preloaded and a plurality of response files are preloaded at the response positions respectively. Additionally, a command value may be saved.

In step 420, information is received and then whether the information is the command value is determined. Then, the information at the command position is allocated in step 430 when the information is the command value. In step 440, the information at the command position is parsed to find out an index of the information, wherein the index assigns to one of the response files. In step 450, the information is executed at the command position to generate a response value. In step 460, the response value at one of the response positions is allocated according to the index, wherein the one of the response files is preloaded at the one of the response positions.

In the method 400, it should be noted that one step might be performed in series, in parallel, in combination, or otherwise in conjunction with another if the specific order is not described or inferred in the embodiment,

Accordingly, in the method 400, a plurality of procedure files, such as above-mentioned command file and response files, are preloaded in the memory device. The host can assign different response file for reading the different response value whenever the host commands the memory device, so as to prevent hacker sniff the memory device.

Please refer to FIG. 4 again. In FIG. 4, the method 400 comprises steps 470. In step 470, the information is stored in the flash memory when the information is not the command value. Accordingly, the host can access data in the memory device, besides it may command the memory device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory device, comprising:
a flash memory comprising a command position preloaded a command file and a plurality of response positions preloaded a plurality of response files respectively;
means for receiving information;
means for determining whether the information is a command value;
means for allocating the information at the command position when the information is the command value;
means for parsing the information to find out an index of the information, wherein the index assigns to one of the response files;
means for executing the information at the command position to generate a response value; and
means for allocating the response value at one of the response positions according to the index, wherein the one of the response files is preloaded at the one of the response positions.

2. The memory device as claimed in claim 1, further comprising:
means for storing the information in the flash memory when the information is not the command value.

3. A method for operating a memory device, wherein the memory device has a flash memory having a command position and a plurality of response positions, the method comprising:
saving a command value;
preloading a command file at the command position;
preloading a plurality of response files at the response positions respectively;
receiving information;
determining whether the information is the command value;
allocating the information at the command position when the information is the command value;
parsing the information at the command position to find out an index of the information, wherein the index assigns to one of the response files;
executing the information at the command position to generate a response value; and
allocating the response value at one of the response positions according to the index, wherein the one of the response files is preloaded at the one of the response positions.

4. The method device as claimed in claim 2, further comprising:
storing the information in the flash memory when the information is not the command value.
